(19) United States
(12) Patent Application Publication
(10) Pub. No.: US 2026/0151899 A1
(43) Pub. Date: Jun. 4, 2026

(54) INTEGRATED HYDRO-ELECTRIC ACTUATION AND THERMAL MANAGEMENT SYSTEM WITH DISTRIBUTED ELECTROLYTIC ENERGY STORAGE

(71) Applicant: Samuel Odeh, Burr Ridge, IL (US)

(72) Inventor: Samuel Odeh, Burr Ridge, IL (US)

(21) Appl. No.: 19/458,706

(22) Filed: Jan. 24, 2026

(51) Int. Cl. B25J 9/14; B25J 19/00; F15B 15/18; F15B 21/041; H01M 8/04029; H01M 8/06; H01M 8/18

(52) U.S. Cl. CPC B25J 9/144; B25J 19/0012; B25J 19/0025; F15B 15/18; F15B 21/041; H01M 8/04029; H01M 8/0693; H01M 8/188; H01M 2250/10

(57) ABSTRACT

A robotic power and actuation system is disclosed in which a single circulating working fluid performs hydraulic actuation, electrochemical energy storage and delivery, and thermal management functions. The system replaces conventional inert hydraulic fluids and centralized battery packs with an electrochemically active liquid electrolyte having sufficient energy density and mechanical properties to support pressurized fluid actuation. The electrolyte is circulated through a distributed conduit network within the robotic structure to drive hybrid soft and rigid actuators, supply electrical energy to distributed electrical storage or conversion elements, and absorb and transport heat away from high-power electronic components. By integrating power delivery, mechanical actuation, and thermal regulation into a unified fluid loop, the system reduces mass, improves energy utilization efficiency, enhances fault tolerance through distributed energy storage, and enables rapid replenishment of energy via fluid exchange without disassembly or system shutdown.

### BACKGROUND OF THE INVENTION

### 1. Field of the Invention

The present disclosure relates to robotic actuation systems, electrochemical energy storage, and thermal management. More specifically, the disclosure relates to integrated architectures in which a circulating fluid performs multiple functional roles, including mechanical actuation, electrical energy delivery, and heat transfer.

### 2. Description of Related Art

Conventional robotic platforms typically employ discrete subsystems for power storage, actuation, and thermal regulation. Electrical energy is commonly stored in centralized battery packs, while mechanical motion is generated by electric motors or hydraulic actuators supplied by separate hydraulic circuits. Thermal management is often handled by dedicated cooling components, such as heat sinks, fans, or liquid cooling loops.

This separation of subsystems increases system mass, volume, and complexity, and can reduce overall efficiency. Centralized battery packs contribute significant weight but do not participate in mechanical work or heat transport. Similarly, high-power electric motors and power electronics generate substantial waste heat, necessitating additional cooling infrastructure.

Existing hydraulic systems provide high force density but typically rely on inert working fluids that do not contribute to electrical energy storage or delivery. As a result, the energy, motion, and cooling functions of robotic systems remain largely decoupled, limiting operational endurance and adaptability.

Accordingly, there exists a need for a robotic architecture that integrates energy storage, actuation, and thermal management into a unified system, reducing redundancy and improving efficiency.

### SUMMARY OF THE INVENTION

The present invention provides an integrated hydro-electric actuation system in which a circulating electrochemically active fluid performs multiple functions within a robotic platform.

In one embodiment, the system includes a network of fluid conduits distributed throughout structural elements of a robot. The conduits carry an electrolyte containing electroactive species. The electrolyte is pressurized and circulated to provide hydraulic force for actuation of joints, limbs, or other mechanical elements.

The system further includes electrochemical conversion units positioned along the fluid network. As the electrolyte passes through these units, electrochemical reactions occur that deliver electrical energy to onboard electronics or actuators. The circulating fluid simultaneously transports heat away from high-power components, providing distributed thermal regulation.

Energy is stored within the electrolyte itself, distributed throughout the fluid network rather than concentrated in a single battery pack. This distributed storage architecture enables continued operation even if a portion of the fluid network is isolated or damaged.

By combining hydraulic actuation, electrochemical energy delivery, and thermal management within a single circulating fluid system, the invention reduces system mass and complexity while increasing functional integration and resilience of robotic platforms.

### DETAILED DESCRIPTION

A robotic power and actuation system is disclosed in which a circulating working fluid performs hydraulic actuation, electrochemical energy storage and delivery, and thermal management functions.

The system comprises a fluid pump configured to circulate a working fluid through a distributed conduit network.

The conduit network extends throughout structural elements of a robotic chassis.

The working fluid comprises an electrolyte capable of storing and transmitting electrochemical energy while maintaining sufficient viscosity and mechanical properties for pressurized hydraulic actuation.

One or more hydraulic actuators are fluidly coupled to the conduit network.

The hydraulic actuators convert fluid pressure into mechanical motion of robot limbs, joints, or load-bearing elements.

A plurality of electrochemical conversion units are positioned at distributed locations along the fluid conduit network.

Each electrochemical conversion unit is configured to extract electrical energy from the circulating electrolyte.

Extracted electrical energy is supplied to local electronic components or distributed actuators.

Mechanical back-pressure generated during actuator deceleration can drive fluid through energy recovery devices to regenerate electrochemical potential in the electrolyte.

The system further comprises thermal management channels integrated with the fluid conduits.

Circulation of the electrolyte absorbs heat from high-power electronic components.

Heated fluid is transported through peripheral regions of the robotic structure.

Heat is dissipated from the fluid to the surrounding environment via conduction, convection, or radiation.

The fluid is recirculated back toward a central reservoir or pump after cooling.

The system further comprises a fluid exchange and conditioning interface.

The interface includes a sealed coupling for detachable connection to an external fluid supply.

The interface includes a filtration subsystem to remove contaminants or degraded electrolyte species from the circulating fluid.

The interface further comprises a control unit configured to coordinate withdrawal of depleted electrolyte and introduction of replenished electrolyte while the robot remains operational.

A portion of the working fluid may be selectively released or atomized to enhance heat dissipation via phase-change cooling.

Hydraulic pressure within the actuators can be dynamically modulated to vary structural stiffness of limbs or load-bearing elements.

Heat generated by electrochemical reactions can be used to condition mechanical seals or fluid pathways in low-temperature environments.

The working fluid may include suspended sealing particles that obstruct fluid leakage upon exposure to ambient pressure.

Fluid can be transferred between robotic systems via a detachable conduit.

At least a portion of the fluid conduits can be integrally formed within load-bearing structural components.

External surface temperature can be regulated via the circulating fluid to reduce detectability by infrared sensors.

The conduit network can comprise multiple independent loops to maintain operation upon failure of a subset of loops.

Electrochemical conversion units are capable of delivering short-duration, high-power electrical output exceeding nominal operating levels.

Fluid viscosity can be adjusted by controlled heating to reduce pumping losses during high-speed operation.

The working fluid can be aqueous and substantially non-flammable.

The system further comprises a distributed center-of-mass modulation capability.

Redistribution of fluid mass within the conduit network alters the robot's center of mass during operation.

The system further comprises a maintenance flow mode.

During extended inactivity, fluid circulation is reduced to a maintenance rate sufficient to sustain essential system functions.

The system further comprises energy recovery devices positioned at strategic points in the conduit network.

Mechanical energy from actuator deceleration or limb motion can drive fluid through the energy recovery devices.

Recovered energy regenerates electrochemical potential within the circulating electrolyte.

The system further comprises sensors to monitor fluid pressure, flow rate, temperature, and electrochemical potential.

Sensor data is transmitted to a control unit for real-time management of actuation, power delivery, and thermal regulation.

The system further comprises control logic to dynamically modulate pump speed, actuator pressure, and electrochemical conversion rates.

The system further comprises distributed electrochemical conversion units with individual control capability.

Each unit adjusts electrical output based on local power demand and fluid characteristics.

The system further comprises a feedback loop integrating actuator load, fluid temperature, and electrical output.

Feedback data is used to optimize fluid circulation patterns for efficiency and thermal balance.

The system further comprises modular hydraulic actuators compatible with the electrochemically active fluid.

Actuators include soft, rigid, or hybrid constructions designed to operate under pressurized electrolyte conditions.

The system further comprises safety interlocks to prevent overpressure or fluid overheating.

Safety interlocks can shut down pump operation or isolate fluid loops in case of emergency.

The system further comprises a diagnostic subsystem to detect fluid contamination or degradation.

The diagnostic subsystem can trigger filtration, additive injection, or fluid replacement without system shutdown.

The system further comprises a fluid exchange interface configured to connect the robot to external service stations.

The interface enables withdrawal of depleted electrolyte and introduction of replenished electrolyte while the robot remains operational.

The system further comprises a filtration subsystem within the interface.

The filtration subsystem removes contaminants, particulate matter, or degraded electroactive species from the circulating fluid.

The system further comprises a control unit coordinating fluid exchange operations.

The control unit monitors fluid composition, flow rate, and pressure during exchange.

The system further comprises additive injection capability.

Additives restore electrochemical performance or adjust fluid viscosity for optimized operation.

The system further comprises safety interlocks during fluid exchange.

Interlocks prevent overpressure, spillage, or exposure of high-energy electrolyte to ambient conditions.

The system further comprises a detachable conduit standard compatible with multiple robotic units.

Detachable conduits allow sharing or transfer of working fluid between separate robots.

The system further comprises monitoring of electrochemical potential and thermal status during fluid transfer.

Monitoring ensures that actuator performance and thermal management are not compromised.

The system further comprises a maintenance flow mode during extended inactivity.

Maintenance flow preserves minimal circulation to prevent fluid stratification or local freezing.

The system further comprises modular interface adaptors for different fluid supply sources.

Adaptors allow compatibility with service stations or mobile refueling units.

The system further comprises automatic verification of fluid compatibility prior to exchange.

Verification prevents introduction of incompatible electrolytes or foreign contaminants into the system.

The system further comprises distributed hydraulic actuators positioned throughout the robotic chassis.

Each actuator is fluidly coupled to one or more conduit loops to convert pressurized fluid into mechanical motion.

Actuators can include linear pistons, rotary actuators, or hybrid soft-rigid mechanisms.

The system further comprises dynamic pressure modulation within each actuator.

Pressure modulation allows adjustment of limb stiffness, load-bearing capacity, or motion responsiveness.

The system further comprises electrochemical conversion units embedded adjacent to actuators.

Each conversion unit extracts electrical energy from the circulating electrolyte for local electronics.

The system further comprises energy recovery pathways integrated with the actuator loops.

Back-pressure generated during actuator deceleration drives fluid through energy recovery devices.

Recovered energy is stored electrochemically in the circulating fluid, increasing system efficiency.

The system further comprises temperature monitoring sensors at actuators and conduit junctions.

Temperature data informs thermal management strategies, including fluid circulation rate adjustments.

The system further comprises a control unit for distributed actuator coordination.

The control unit integrates actuator load, hydraulic pressure, and electrochemical energy availability to optimize performance.

The system further comprises fluid conduit branching to multiple actuators from a central pump.

Branching allows selective isolation of actuator loops for maintenance or fault tolerance.

The system further comprises sealing particles suspended in the working fluid.

Sealing particles obstruct leaks when conduits or actuators are exposed to ambient pressure.

The system further comprises integrated diagnostic routines for each actuator.

Diagnostics detect flow irregularities, pressure drops, or electrical extraction anomalies for corrective action.

The system further comprises a network of fluid conduits distributed through load-bearing structural components.

Conduits are integrally formed or embedded within limbs, chassis, and appendages of the robot.

The conduit network supports multiple independent fluid loops.

Independent loops maintain hydraulic and electrochemical function if a subset of conduits fails.

The system further comprises thermal regulation channels integrated with the conduits.

Circulating electrolyte absorbs heat from high-power electronics and dissipates it through external surfaces.

Heat dissipation occurs via conduction, convection, or radiation, depending on component placement.

The system further comprises a control algorithm to balance fluid circulation among loops.

Circulation balancing ensures uniform temperature distribution and optimal energy delivery.

The system further comprises selective fluid atomization or phase-change cooling within heat-critical regions.

Phase-change cooling enhances thermal dissipation while maintaining electrochemical integrity of the electrolyte.

The system further comprises sensors for monitoring flow rate, pressure, temperature, and electrochemical potential at multiple locations.

Sensor data informs adaptive control of pump speed, loop isolation, and energy recovery devices.

The system further comprises a predictive flow management routine.

Predictive management anticipates actuator demands, optimizing fluid distribution for both mechanical actuation and energy extraction.

The system further comprises a maintenance flow mode to preserve essential functions during periods of low activity.

The maintenance mode reduces pump speed and circulation to conserve energy while sustaining thermal regulation and minimal actuation capability.

The system further comprises safety interlocks for overpressure, over-temperature, and fluid contamination.

Interlocks can automatically isolate loops, shut down pumps, or trigger alerts for operator intervention.

The system thereby provides integrated hydraulic, electrical, and thermal management with high efficiency, fault tolerance, and operational safety.

The system further comprises a fluid exchange interface for external replenishment or servicing.

The interface includes a sealed coupling configured to detachably connect to an external fluid supply.

The interface allows withdrawal of depleted electrolyte while the robot remains operational.

Replenishment of fresh electrolyte is coordinated by a control unit without interrupting robot operation.

The system further comprises a filtration subsystem within the fluid exchange interface.

The filtration subsystem removes particulate matter, degraded electroactive species, and contaminants from the circulating fluid.

The system further comprises an additive injection capability.

Additives restore electrochemical performance, adjust viscosity, or condition the fluid for specific environmental conditions.

The system further comprises monitoring of fluid pressure, temperature, and electrochemical potential during exchange operations.

Monitoring ensures that actuation, power delivery, and thermal regulation are not compromised.

The system further comprises a control algorithm to synchronize fluid exchange with ongoing actuation cycles.

Synchronization prevents pressure fluctuations that could interfere with hydraulic actuator performance.

The system further comprises compatibility adaptors for connection with standardized service stations or mobile refueling units.

Adaptors ensure interoperability between multiple robot units using the same fluid standard.

The system further comprises diagnostic routines during exchange operations.

Diagnostics detect fluid contamination, degradation, or leakage, triggering filtration or additive correction.

The system further comprises safety interlocks during fluid exchange.

Interlocks prevent overpressure, spillage, or exposure of the electrolyte to ambient conditions.

The system further comprises a communication interface transmitting fluid status and exchange progress to a remote operator or supervisory system.

The system thereby enables safe, efficient, and continuous electrolyte exchange without interrupting robotic operation.

The system further comprises electrochemical conversion units distributed along the fluid conduit network.

Each conversion unit is configured to extract electrical energy from the circulating electrolyte.

Electrical energy is supplied to local actuators, sensors, and electronic components.

Conversion units can deliver short-duration high-power outputs exceeding nominal operating levels.

The system further comprises energy recovery devices integrated with actuator loops.

Mechanical back-pressure from decelerating actuators drives fluid through energy recovery devices.

Recovered energy is stored electrochemically within the circulating electrolyte.

The system further comprises control logic to optimize energy extraction from multiple conversion units.

Control logic balances electrical demand with available electrochemical potential and actuator pressure requirements.

The system further comprises sensors monitoring voltage, current, and electrochemical potential at each conversion unit.

Sensor data informs real-time adjustments of extraction rate and local fluid pressure.

The system further comprises thermal monitoring at conversion units.

Heat generated by electrochemical reactions is absorbed into the circulating fluid for distributed thermal management.

The system further comprises predictive energy allocation logic.

Predictive logic anticipates actuator power demand and adjusts electrochemical extraction accordingly.

The system further comprises redundancy in conversion units.

Redundant units maintain system operation if a subset of electrochemical units fails.

The system further comprises modular housing for conversion units, facilitating maintenance and replacement.

Each module integrates with fluid conduits, sensors, and electrical interfaces.

The system thereby provides distributed, fault-tolerant electrical energy delivery integrated with hydraulic actuation and thermal regulation.

The system further comprises distributed hydraulic actuators positioned throughout the robotic structure.

Each actuator is fluidly coupled to one or more conduit loops to convert pressurized fluid into mechanical motion.

Actuators may include linear pistons, rotary actuators, or hybrid soft-rigid mechanisms.

The system further comprises dynamic pressure modulation within each actuator.

Pressure modulation allows adjustment of limb stiffness, damping, and load-bearing capacity.

The system further comprises sensors at each actuator for monitoring fluid pressure, position, and motion.

Sensor data is transmitted to a central control unit for real-time actuation management.

The system further comprises energy recovery pathways integrated with actuator loops.

Mechanical back-pressure generated during actuator deceleration drives fluid through energy recovery devices to regenerate electrochemical potential.

The system further comprises a feedback loop integrating actuator load, fluid pressure, and electrochemical energy availability.

The feedback loop informs control adjustments to optimize performance, efficiency, and thermal regulation.

The system further comprises modular actuator design to accommodate varying robotic limb sizes and load requirements.

Actuators are compatible with the circulating electrochemical fluid for both hydraulic motion and energy delivery.

The system further comprises sealing mechanisms and suspended sealing particles in the fluid.

Sealing prevents leaks under ambient or elevated pressure conditions.

The system further comprises a diagnostic routine for each actuator.

Diagnostics detect flow irregularities, abnormal pressure, or reduced energy extraction for corrective action.

The system further comprises a fluid bypass capability for actuator maintenance or isolation without disrupting overall system operation.

The system further comprises a predictive actuation control module.

Predictive control anticipates required actuator motion to optimize fluid distribution, energy extraction, and thermal management.

The system further comprises a distributed fluid conduit network embedded within load-bearing structural elements of the robot.

Conduits may be integrally formed in limbs, chassis, or other structural components.

The conduit network can include multiple independent loops to maintain operation if a subset fails.

The system further comprises fluid circulation channels integrated with thermal management pathways.

Circulating electrolyte absorbs heat from high-power electronic components and distributes it throughout the structure.

Heat is dissipated through exposed surfaces using conduction, convection, or radiation.

The system further comprises a control algorithm that balances fluid circulation among loops to maintain uniform thermal and hydraulic performance.

The system further comprises selective fluid atomization or phase-change cooling in heat-critical areas.

Phase-change cooling enhances heat transfer without compromising electrochemical integrity of the working fluid.

The system further comprises sensors monitoring pressure, flow rate, temperature, and electrochemical potential at multiple points in the conduit network.

Sensor data is transmitted to a central control unit for real-time management of hydraulic, electrical, and thermal subsystems.

The system further comprises a predictive fluid management module.

Predictive management anticipates actuator demand and adjusts fluid flow and distribution for optimal performance.

The system further comprises maintenance flow operation for extended inactivity.

Maintenance flow sustains minimal circulation to preserve electrochemical integrity, prevent freezing, or avoid stratification.

The system further comprises safety interlocks for overpressure, over-temperature, and fluid contamination.

Interlocks can automatically isolate loops, shut down pumps, or trigger alerts for operator intervention.

The system thereby integrates hydraulic actuation, distributed energy storage, and thermal regulation with high efficiency and resilience.

The system further comprises a fluid exchange and conditioning interface for external replenishment or servicing.

The interface includes a sealed coupling configured for detachable connection to an external fluid supply.

The interface allows withdrawal of depleted electrolyte while the robotic system remains operational.

Replenishment of fresh electrolyte is coordinated by a control unit without interrupting ongoing operations.

The system further comprises a filtration subsystem integrated within the interface.

The filtration subsystem removes particulate matter, degraded electroactive species, and contaminants from the circulating fluid.

The system further comprises additive injection capability to restore electrolyte performance or adjust viscosity.

The system further comprises sensors monitoring fluid pressure, temperature, and electrochemical potential during exchange.

Sensor data ensures that actuation, power delivery, and thermal regulation are maintained within operational limits.

The system further comprises synchronization logic coordinating fluid exchange with actuator cycles.

Synchronization prevents pressure fluctuations that could degrade hydraulic performance.

The system further comprises standardized adaptors for compatibility with service stations or mobile refueling units.

Adaptors ensure interoperability across multiple robotic units utilizing the same electrolyte standard.

The system further comprises automated verification of fluid compatibility prior to exchange.

Verification prevents introduction of incompatible electrolytes or contaminants into the network.

The system further comprises safety interlocks preventing overpressure, spillage, or exposure of the electrolyte to ambient conditions.

The system further comprises a communication interface reporting fluid status and exchange progress to remote operators or supervisory systems.

The system thereby enables safe, efficient, and continuous electrolyte exchange without operational interruption.

The system further comprises a distributed network of electrochemical conversion units positioned along the fluid conduit network.

Each conversion unit is configured to extract electrical energy from the circulating electrolyte and supply local electronic loads.

Conversion units can provide short-duration high-power output exceeding nominal operating levels.

The system further comprises energy recovery devices integrated with actuator loops.

Back-pressure generated during actuator deceleration drives fluid through energy recovery devices to regenerate electrochemical potential.

The system further comprises control logic to optimize energy extraction across multiple conversion units.

Control logic balances electrical demand, local fluid pressure, and actuator requirements.

The system further comprises voltage, current, and electrochemical potential sensors at each conversion unit.

Sensor data informs real-time adjustments of extraction rate and local hydraulic parameters.

The system further comprises thermal sensors at conversion units to monitor heat generation.

Generated heat is absorbed by the circulating fluid for distributed thermal management.

The system further comprises predictive energy allocation logic to anticipate actuator power demand.

The system further comprises redundancy in conversion units to maintain operation if a subset fails.

Modular housing for each conversion unit facilitates maintenance, replacement, and integration with conduit networks.

The system further comprises hydraulic actuators distributed throughout the robotic chassis.

Each actuator is fluidly coupled to one or more conduit loops to convert pressurized fluid into mechanical motion.

Actuators include linear, rotary, and hybrid soft-rigid designs compatible with electrochemically active fluid.

The system further comprises dynamic pressure modulation within actuators to vary stiffness and load-bearing capacity.

Actuators are equipped with sensors to monitor fluid pressure, position, and applied force.

Sensor data is transmitted to a central control unit for real-time actuator management.

The system further comprises energy recovery pathways integrated with actuator loops.

Back-pressure from actuator deceleration drives fluid through energy recovery devices to regenerate electrochemical potential.

The system further comprises a feedback loop integrating actuator load, fluid pressure, and electrochemical energy availability.

The feedback loop optimizes actuator performance, thermal management, and energy efficiency.

The system further comprises modular actuator designs for varying limb size and mechanical requirements.

Actuators are compatible with circulating electrolyte for combined hydraulic motion and energy delivery.

The system further comprises sealing mechanisms and suspended sealing particles to prevent fluid leakage.

The system further comprises a diagnostic routine for each actuator detecting flow anomalies, pressure drops, or reduced energy extraction.

The system further comprises fluid bypass capability to isolate actuators during maintenance without disrupting overall function.

The system further comprises predictive actuation control to anticipate motion and optimize fluid distribution, energy extraction, and thermal regulation.

The system further comprises a distributed fluid conduit network embedded within load-bearing structural components of the robot.

Conduits may be integrally formed within limbs, chassis, or appendages.

The conduit network can include multiple independent loops to maintain hydraulic and electrochemical function if a subset of conduits fails.

The system further comprises thermal regulation channels integrated with the conduit network.

Circulating electrolyte absorbs heat from high-power electronics and distributes it throughout structural elements.

Heat is dissipated via conduction, convection, or radiation through exposed surfaces of the robotic structure.

The system further comprises a control algorithm to balance fluid circulation among loops for uniform thermal and hydraulic performance.

The system further comprises selective fluid atomization or phase-change cooling within heat-critical regions to enhance heat transfer.

Phase-change cooling improves thermal dissipation without compromising electrochemical integrity of the working fluid.

The system further comprises sensors monitoring pressure, flow rate, temperature, and electrochemical potential at multiple points within the conduit network.

Sensor data is communicated to a central control unit for real-time hydraulic, electrical, and thermal management.

The system further comprises a predictive fluid management module.

Predictive management anticipates actuator demand and adjusts fluid flow for optimal actuation and energy extraction.

The system further comprises maintenance flow operation during extended inactivity to sustain minimal circulation.

Maintenance flow prevents fluid stratification, freezing, or degradation of electrochemical species.

The system further comprises safety interlocks for overpressure, overheating, or fluid contamination.

Interlocks can automatically isolate loops, shut down pumps, or trigger alerts.

The system thereby integrates hydraulic actuation, distributed energy storage, and thermal regulation with enhanced efficiency and operational resilience.

The system further comprises a fluid exchange and conditioning interface for external replenishment or servicing.

The interface includes a sealed coupling configured for detachable connection to an external fluid supply.

The interface allows withdrawal of depleted electrolyte while the robotic system remains operational.

Replenishment of fresh electrolyte is coordinated by a control unit without interrupting ongoing actuation or energy delivery.

The system further comprises a filtration subsystem integrated within the fluid exchange interface.

The filtration subsystem removes contaminants, degraded electroactive species, and particulate matter from the circulating fluid.

The system further comprises an additive injection capability.

Additives restore electrochemical performance, adjust fluid viscosity, or condition the electrolyte for environmental conditions.

The system further comprises sensors monitoring fluid pressure, temperature, and electrochemical potential during exchange.

Sensor data ensures actuator performance, energy delivery, and thermal regulation are maintained within operational limits.

The system further comprises synchronization logic coordinating fluid exchange with ongoing actuator cycles.

Synchronization prevents pressure fluctuations that could compromise hydraulic performance.

The system further comprises standardized adaptors for connection with service stations or mobile refueling units.

Adaptors ensure compatibility and interoperability across multiple robotic units using the same electrolyte standard.

The system further comprises automated verification of fluid compatibility prior to exchange.

Verification prevents the introduction of incompatible electrolytes or contaminants into the fluid network.

The system further comprises safety interlocks to prevent overpressure, spillage, or exposure of the electrolyte to ambient conditions.

The system further comprises a communication interface reporting fluid status and exchange progress to remote operators or supervisory systems.

The system thereby enables safe, efficient, and continuous electrolyte exchange without interrupting robotic operation.

The system further comprises distributed electrochemical conversion units positioned along the fluid conduit network.

Each conversion unit extracts electrical energy from the circulating electrolyte for local electronic loads or actuators.

Conversion units are capable of delivering short-duration, high-power output exceeding nominal operating levels.

The system further comprises energy recovery devices integrated with actuator loops.

Back-pressure generated during actuator deceleration drives fluid through energy recovery devices to regenerate electrochemical potential.

The system further comprises control logic optimizing energy extraction across multiple conversion units.

Control logic balances electrical demand, fluid pressure, and actuator requirements.

The system further comprises sensors monitoring voltage, current, and electrochemical potential at each conversion unit.

Sensor data informs real-time adjustments of extraction rate and local fluid parameters.

The system further comprises thermal sensors at conversion units to monitor heat generation.

Generated heat is absorbed by the circulating fluid for distributed thermal regulation.

The system further comprises predictive energy allocation logic.

Predictive logic anticipates actuator power demand and adjusts electrochemical extraction accordingly.

The system further comprises redundancy in conversion units.

Redundant units maintain system operation if a subset of electrochemical units fails.

The system further comprises modular housing for conversion units to facilitate maintenance, replacement, and integration with the conduit network.

The system thereby provides distributed, fault-tolerant electrical energy delivery integrated with hydraulic actuation and thermal management.

The system further comprises distributed hydraulic actuators positioned throughout the robotic chassis.

Each actuator is fluidly coupled to one or more conduit loops to convert pressurized fluid into mechanical motion.

Actuators include linear pistons, rotary actuators, or hybrid soft-rigid mechanisms compatible with the circulating electrolyte.

The system further comprises dynamic pressure modulation within each actuator.

Pressure modulation allows adjustment of limb stiffness, damping, and load-bearing capacity.

Each actuator is equipped with sensors monitoring fluid pressure, position, and applied force.

Sensor data is transmitted to a central control unit for real-time actuator management.

The system further comprises energy recovery pathways integrated with actuator loops.

Back-pressure from actuator deceleration drives fluid through energy recovery devices to regenerate electrochemical potential.

The system further comprises a feedback loop integrating actuator load, fluid pressure, and electrochemical energy availability.

The feedback loop optimizes actuator performance, thermal regulation, and energy efficiency.

The system further comprises modular actuator designs to accommodate varying limb size and mechanical requirements.

Actuators are compatible with circulating electrolyte for combined hydraulic motion and energy delivery.

The system further comprises sealing mechanisms and suspended sealing particles in the working fluid to prevent leakage.

The system further comprises diagnostic routines for each actuator to detect flow anomalies, pressure drops, or reduced energy extraction.

The system further comprises fluid bypass capability to isolate actuators during maintenance without disrupting overall system operation.

The system further comprises predictive actuation control to anticipate required motion and optimize fluid distribution, energy extraction, and thermal management.

The system further comprises a network of fluid conduits embedded within load-bearing structural elements of the robot.

Conduits may be integrally formed within limbs, chassis, or appendages.

The conduit network can include multiple independent loops to maintain operation if a subset of conduits fails.

The system further comprises thermal regulation channels integrated with the conduit network.

Circulating electrolyte absorbs heat from high-power electronics and distributes it throughout structural components.

Heat is dissipated via conduction, convection, or radiation through exposed surfaces of the robot.

The system further comprises a control algorithm to balance fluid circulation among loops for uniform thermal and hydraulic performance.

The system further comprises selective fluid atomization or phase-change cooling within heat-critical regions to enhance heat transfer.

Phase-change cooling improves thermal dissipation without compromising electrochemical integrity of the fluid.

The system further comprises sensors monitoring pressure, flow rate, temperature, and electrochemical potential at multiple locations in the conduit network.

Sensor data is communicated to a central control unit for real-time management of hydraulic, electrical, and thermal subsystems.

The system further comprises a predictive fluid management module.

Predictive management anticipates actuator demand and adjusts fluid flow for optimal actuation and energy extraction.

The system further comprises maintenance flow operation during extended inactivity to sustain minimal circulation.

Maintenance flow prevents fluid stratification, freezing, or degradation of electrochemical species.

The system further comprises safety interlocks for overpressure, over-temperature, or fluid contamination.

Interlocks can automatically isolate loops, shut down pumps, or trigger alerts.

The system thereby integrates hydraulic actuation, distributed energy storage, and thermal regulation with enhanced efficiency and operational resilience.

The system further comprises a fluid exchange and conditioning interface for external replenishment or servicing.

The interface includes a sealed coupling configured for detachable connection to an external fluid supply.

The interface allows withdrawal of depleted electrolyte while the robot remains operational.

Replenishment of fresh electrolyte is coordinated by a control unit without interrupting ongoing actuation or energy delivery.

The system further comprises a filtration subsystem integrated within the fluid exchange interface.

The filtration subsystem removes particulate matter, degraded electroactive species, and contaminants from the circulating fluid.

The system further comprises an additive injection capability.

Additives restore electrochemical performance, adjust fluid viscosity, or condition the electrolyte for specific environmental conditions.

The system further comprises sensors monitoring fluid pressure, temperature, and electrochemical potential during exchange.

Sensor data ensures actuator performance, energy delivery, and thermal regulation remain within operational limits.

The system further comprises synchronization logic coordinating fluid exchange with ongoing actuator cycles.

Synchronization prevents pressure fluctuations that could compromise hydraulic performance.

The system further comprises standardized adaptors for connection with service stations or mobile refueling units.

Adaptors ensure compatibility and interoperability across multiple robotic units using the same electrolyte standard.

The system further comprises automated verification of fluid compatibility prior to exchange.

Verification prevents introduction of incompatible electrolytes or contaminants into the fluid network.

The system further comprises safety interlocks to prevent overpressure, spillage, or exposure of the electrolyte to ambient conditions.

The system further comprises a communication interface reporting fluid status and exchange progress to remote operators or supervisory systems.

The system thereby enables safe, efficient, and continuous electrolyte exchange without interrupting robotic operation.

The system further comprises distributed electrochemical conversion units positioned along the fluid conduit network.

Each conversion unit extracts electrical energy from the circulating electrolyte for powering local electronic loads or actuators.

Conversion units can provide short-duration, high-power output exceeding nominal operating levels.

The system further comprises energy recovery devices integrated with actuator loops.

Mechanical back-pressure generated during actuator deceleration drives fluid through energy recovery devices to regenerate electrochemical potential.

The system further comprises control logic to optimize energy extraction across multiple conversion units.

Control logic balances electrical demand, local fluid pressure, and actuator requirements.

The system further comprises voltage, current, and electrochemical potential sensors at each conversion unit.

Sensor data informs real-time adjustments of extraction rate and local hydraulic parameters.

The system further comprises thermal sensors at conversion units to monitor heat generation.

Generated heat is absorbed by the circulating fluid for distributed thermal management.

The system further comprises predictive energy allocation logic to anticipate actuator power demand.

The system further comprises redundancy in conversion units to maintain operation if a subset fails.

Modular housing for each conversion unit facilitates maintenance, replacement, and integration with the conduit network.

The system thereby provides distributed, fault-tolerant electrical energy delivery integrated with hydraulic actuation and thermal management.

The system further comprises hydraulic actuators distributed throughout the robotic chassis.

Each actuator is fluidly coupled to one or more conduit loops to convert pressurized fluid into mechanical motion.

Actuators may include linear pistons, rotary actuators, or hybrid soft-rigid mechanisms compatible with the circulating electrolyte.

The system further comprises dynamic pressure modulation within each actuator.

Pressure modulation allows adjustment of limb stiffness, damping, and load-bearing capacity.

Each actuator is equipped with sensors monitoring fluid pressure, position, and applied force.

Sensor data is transmitted to a central control unit for real-time actuator management.

The system further comprises energy recovery pathways integrated with actuator loops.

Back-pressure from actuator deceleration drives fluid through energy recovery devices to regenerate electrochemical potential.

The system further comprises a feedback loop integrating actuator load, fluid pressure, and electrochemical energy availability.

The feedback loop optimizes actuator performance, thermal regulation, and energy efficiency.

The system further comprises modular actuator designs for varying limb size and mechanical requirements.

Actuators are compatible with circulating electrolyte for combined hydraulic motion and energy delivery.

The system further comprises sealing mechanisms and suspended sealing particles in the working fluid to prevent leakage.

The system further comprises diagnostic routines for each actuator detecting flow anomalies, pressure drops, or reduced energy extraction.

The system further comprises fluid bypass capability to isolate actuators during maintenance without disrupting overall system operation.

The system further comprises predictive actuation control to anticipate required motion and optimize fluid distribution, energy extraction, and thermal management.

The system further comprises a network of fluid conduits embedded within load-bearing structural components of the robotic chassis.

Conduits may be integrally formed within limbs, frames, or appendages to minimize added mass.

The conduit network can include multiple independent loops to maintain operation if a subset fails.

The system further comprises thermal regulation channels integrated with the conduit network.

Circulating electrolyte absorbs heat from high-power electronic components and distributes it throughout structural elements.

Heat is dissipated via conduction, convection, or radiation through the external surfaces of the robot.

The system further comprises a control algorithm to balance fluid circulation among loops to maintain uniform thermal and hydraulic performance.

The system further comprises selective fluid atomization or phase-change cooling within heat-critical regions to enhance heat transfer.

Phase-change cooling improves thermal dissipation while maintaining electrochemical integrity of the working fluid.

The system further comprises sensors monitoring pressure, flow rate, temperature, and electrochemical potential at multiple locations in the conduit network.

Sensor data is communicated to a central control unit for real-time management of hydraulic, electrical, and thermal subsystems.

The system further comprises a predictive fluid management module.

Predictive management anticipates actuator demand and adjusts fluid flow for optimal actuation and energy extraction.

The system further comprises maintenance flow operation during extended inactivity.

Maintenance flow preserves minimal circulation to prevent fluid stratification, freezing, or degradation of electrochemical species.

The system further comprises safety interlocks for overpressure, over-temperature, or fluid contamination.

Interlocks can automatically isolate loops, shut down pumps, or trigger alerts.

The system thereby integrates hydraulic actuation, distributed energy storage, and thermal regulation with enhanced efficiency and operational resilience.

The system further comprises a fluid exchange and conditioning interface for external replenishment or servicing.

The interface includes a sealed coupling configured for detachable connection to an external fluid supply.

The interface allows withdrawal of depleted electrolyte while the robot remains operational.

Replenishment of fresh electrolyte is coordinated by a control unit without interrupting ongoing actuation or energy delivery.

The system further comprises a filtration subsystem integrated within the fluid exchange interface.

The filtration subsystem removes particulate matter, degraded electroactive species, and contaminants from the circulating fluid.

The system further comprises additive injection capability to restore electrolyte performance or adjust viscosity.

The system further comprises sensors monitoring fluid pressure, temperature, and electrochemical potential during exchange.

Sensor data ensures that actuator performance, energy delivery, and thermal regulation remain within operational limits.

The system further comprises synchronization logic coordinating fluid exchange with ongoing actuator cycles.

Synchronization prevents pressure fluctuations that could compromise hydraulic performance.

The system further comprises standardized adaptors for connection with service stations or mobile refueling units.

Adaptors ensure compatibility and interoperability across multiple robotic units using the same electrolyte standard.

The system further comprises automated verification of fluid compatibility prior to exchange.

Verification prevents introduction of incompatible electrolytes or contaminants into the fluid network.

The system further comprises safety interlocks to prevent overpressure, spillage, or exposure of the electrolyte to ambient conditions.

The system further comprises a communication interface reporting fluid status and exchange progress to remote operators or supervisory systems.

The system thereby enables safe, efficient, and continuous electrolyte exchange without interrupting robotic operation.

The system further comprises distributed electrochemical conversion units positioned along the fluid conduit network.

Each conversion unit extracts electrical energy from the circulating electrolyte to supply local actuators, sensors, or electronics.

Conversion units are capable of delivering short-duration, high-power output exceeding nominal operating levels.

The system further comprises energy recovery devices integrated with actuator loops.

Mechanical back-pressure from actuator deceleration drives fluid through energy recovery devices to regenerate electrochemical potential.

The system further comprises control logic to optimize energy extraction across multiple conversion units.

Control logic balances electrical demand with available fluid pressure and actuator requirements.

The system further comprises sensors monitoring voltage, current, and electrochemical potential at each conversion unit.

Sensor data informs real-time adjustments of extraction rates and local hydraulic parameters.

The system further comprises thermal sensors at each conversion unit to monitor heat generation.

Heat generated during electrochemical reactions is absorbed by the circulating fluid for distributed thermal management.

The system further comprises predictive energy allocation logic to anticipate actuator power demand.

The system further comprises redundant conversion units to maintain operation if a subset fails.

Modular housing for each conversion unit facilitates maintenance, replacement, and integration with the conduit network.

The system thereby provides distributed, fault-tolerant electrical energy delivery integrated with hydraulic actuation and thermal management.

The system further comprises hydraulic actuators distributed throughout the robotic chassis.

Each actuator is fluidly coupled to one or more conduit loops to convert pressurized fluid into mechanical motion.

Actuators may include linear pistons, rotary actuators, or hybrid soft-rigid designs compatible with the circulating electrolyte.

The system further comprises dynamic pressure modulation within actuators.

Pressure modulation allows adjustment of stiffness, damping, and load-bearing capacity.

Each actuator is equipped with sensors to monitor fluid pressure, actuator position, and applied force.

Sensor data is transmitted to a central control unit for real-time actuator management.

The system further comprises energy recovery pathways integrated with actuator loops.

Back-pressure from actuator deceleration drives fluid through energy recovery devices to regenerate electrochemical potential.

The system further comprises a feedback loop integrating actuator load, fluid pressure, and electrochemical energy availability.

The feedback loop optimizes actuator performance, thermal regulation, and energy efficiency.

The system further comprises modular actuator designs to accommodate varying limb sizes and mechanical requirements.

Actuators are compatible with circulating electrolyte for combined hydraulic motion and energy delivery.

The system further comprises sealing mechanisms and suspended sealing particles to prevent fluid leakage.

The system further comprises diagnostic routines for each actuator to detect flow anomalies, pressure drops, or reduced energy extraction.

The system further comprises fluid bypass capability to isolate actuators during maintenance without disrupting overall operation.

The system further comprises predictive actuation control to anticipate required motion and optimize fluid distribution, energy extraction, and thermal management.

The system further comprises a network of fluid conduits embedded within load-bearing structural components of the robot.

Conduits may be integrally formed within limbs, chassis, or appendages to minimize added mass.

The conduit network can include multiple independent loops to maintain operation if a subset of conduits fails.

The system further comprises thermal regulation channels integrated with the conduit network.

Circulating electrolyte absorbs heat from high-power electronic components and distributes it throughout structural elements.

Heat is dissipated via conduction, convection, or radiation through the external surfaces of the robot.

The system further comprises a control algorithm to balance fluid circulation among loops to maintain uniform thermal and hydraulic performance.

The system further comprises selective fluid atomization or phase-change cooling within heat-critical regions to enhance heat transfer.

Phase-change cooling improves thermal dissipation without compromising electrochemical integrity of the working fluid.

The system further comprises sensors monitoring pressure, flow rate, temperature, and electrochemical potential at multiple points within the conduit network.

Sensor data is communicated to a central control unit for real-time management of hydraulic, electrical, and thermal subsystems.

The system further comprises a predictive fluid management module.

Predictive management anticipates actuator demand and adjusts fluid flow for optimal actuation and energy extraction.

The system further comprises maintenance flow operation during extended inactivity to sustain minimal circulation.

Maintenance flow prevents fluid stratification, freezing, or degradation of electrochemical species.

The system further comprises safety interlocks for overpressure, over-temperature, or fluid contamination.

Interlocks can automatically isolate loops, shut down pumps, or trigger alerts.

The system thereby integrates hydraulic actuation, distributed energy storage, and thermal regulation with enhanced efficiency and operational resilience.

The system further comprises a fluid exchange and conditioning interface for external replenishment or servicing.

The interface includes a sealed coupling configured for detachable connection to an external fluid supply.

The interface allows withdrawal of depleted electrolyte while the robotic system remains operational.

Replenishment of fresh electrolyte is coordinated by a control unit without interrupting ongoing actuation or energy delivery.

The system further comprises a filtration subsystem integrated within the fluid exchange interface.

The filtration subsystem removes particulate matter, degraded electroactive species, and contaminants from the circulating fluid.

The system further comprises an additive injection capability.

Additives restore electrochemical performance, adjust fluid viscosity, or condition the electrolyte for specific environmental conditions.

The system further comprises sensors monitoring fluid pressure, temperature, and electrochemical potential during exchange.

Sensor data ensures that actuator performance, energy delivery, and thermal regulation remain within operational limits.

The system further comprises synchronization logic coordinating fluid exchange with ongoing actuator cycles.

Synchronization prevents pressure fluctuations that could compromise hydraulic performance.

The system further comprises standardized adaptors for connection with service stations or mobile refueling units.

Adaptors ensure compatibility and interoperability across multiple robotic units using the same electrolyte standard.

The system further comprises automated verification of fluid compatibility prior to exchange.

Verification prevents introduction of incompatible electrolytes or contaminants into the fluid network.

The system further comprises safety interlocks to prevent overpressure, spillage, or exposure of the electrolyte to ambient conditions.

The system further comprises a communication interface reporting fluid status and exchange progress to remote operators or supervisory systems.

The system thereby enables safe, efficient, and continuous electrolyte exchange without interrupting robotic operation.

The system further comprises distributed electrochemical conversion units positioned along the fluid conduit network.

Each conversion unit extracts electrical energy from the circulating electrolyte for powering local actuators, sensors, or electronics.

Conversion units can provide short-duration, high-power output exceeding nominal operating levels.

The system further comprises energy recovery devices integrated with actuator loops.

Mechanical back-pressure generated during actuator deceleration drives fluid through energy recovery devices to regenerate electrochemical potential.

The system further comprises control logic to optimize energy extraction across multiple conversion units.

Control logic balances electrical demand with available fluid pressure and actuator requirements.

The system further comprises voltage, current, and electrochemical potential sensors at each conversion unit.

Sensor data informs real-time adjustments of extraction rates and local hydraulic parameters.

The system further comprises thermal sensors at each conversion unit to monitor heat generation.

Heat generated during electrochemical reactions is absorbed by the circulating fluid for distributed thermal management.

The system further comprises predictive energy allocation logic to anticipate actuator power demand.

The system further comprises redundant conversion units to maintain operation if a subset fails.

Modular housing for each conversion unit facilitates maintenance, replacement, and integration with the conduit network.

The system thereby provides distributed, fault-tolerant electrical energy delivery integrated with hydraulic actuation and thermal management.

The system further comprises hydraulic actuators distributed throughout the robotic chassis.

Each actuator is fluidly coupled to one or more conduit loops to convert pressurized fluid into mechanical motion.

Actuators may include linear pistons, rotary actuators, or hybrid soft-rigid mechanisms compatible with the circulating electrolyte.

The system further comprises dynamic pressure modulation within actuators.

Pressure modulation allows adjustment of stiffness, damping, and load-bearing capacity.

Each actuator is equipped with sensors to monitor fluid pressure, actuator position, and applied force.

Sensor data is transmitted to a central control unit for real-time actuator management.

The system further comprises energy recovery pathways integrated with actuator loops.

Back-pressure from actuator deceleration drives fluid through energy recovery devices to regenerate electrochemical potential.

The system further comprises a feedback loop integrating actuator load, fluid pressure, and electrochemical energy availability.

The feedback loop optimizes actuator performance, thermal regulation, and energy efficiency.

The system further comprises modular actuator designs to accommodate varying limb sizes and mechanical requirements.

Actuators are compatible with circulating electrolyte for combined hydraulic motion and energy delivery.

The system further comprises sealing mechanisms and suspended sealing particles to prevent fluid leakage.

The system further comprises diagnostic routines for each actuator to detect flow anomalies, pressure drops, or reduced energy extraction.

The system further comprises fluid bypass capability to isolate actuators during maintenance without disrupting overall system operation.

The system further comprises predictive actuation control to anticipate required motion and optimize fluid distribution, energy extraction, and thermal management.

The system further comprises a network of fluid conduits embedded within load-bearing structural components of the robot.

Conduits may be integrally formed within limbs, chassis, or appendages to minimize added mass.

The conduit network can include multiple independent loops to maintain operation if a subset of conduits fails.

The system further comprises thermal regulation channels integrated with the conduit network.

Circulating electrolyte absorbs heat from high-power electronic components and distributes it throughout structural elements.

Heat is dissipated via conduction, convection, or radiation through external surfaces of the robot.

The system further comprises a control algorithm to balance fluid circulation among loops to maintain uniform thermal and hydraulic performance.

The system further comprises selective fluid atomization or phase-change cooling within heat-critical regions to enhance heat transfer.

Phase-change cooling improves thermal dissipation without compromising electrochemical integrity of the working fluid.

The system further comprises sensors monitoring pressure, flow rate, temperature, and electrochemical potential at multiple points within the conduit network.

Sensor data is communicated to a central control unit for real-time management of hydraulic, electrical, and thermal subsystems.

The system further comprises a predictive fluid management module.

Predictive management anticipates actuator demand and adjusts fluid flow for optimal actuation and energy extraction.

The system further comprises maintenance flow operation during extended inactivity to sustain minimal circulation.

Maintenance flow prevents fluid stratification, freezing, or degradation of electrochemical species.

The system further comprises safety interlocks for overpressure, over-temperature, or fluid contamination.

Interlocks can automatically isolate loops, shut down pumps, or trigger alerts.

The system thereby integrates hydraulic actuation, distributed energy storage, and thermal regulation with enhanced efficiency and operational resilience.

The system further comprises a fluid exchange and conditioning interface for external replenishment or servicing.

The interface includes a sealed coupling configured for detachable connection to an external fluid supply.

The interface allows withdrawal of depleted electrolyte while the robot remains operational.

Replenishment of fresh electrolyte is coordinated by a control unit without interrupting ongoing actuation or energy delivery.

The system further comprises a filtration subsystem integrated within the fluid exchange interface.

The filtration subsystem removes particulate matter, degraded electroactive species, and contaminants from the circulating fluid.

The system further comprises additive injection capability to restore electrolyte performance or adjust viscosity.

The system further comprises sensors monitoring fluid pressure, temperature, and electrochemical potential during exchange.

Sensor data ensures actuator performance, energy delivery, and thermal regulation remain within operational limits.

The system further comprises synchronization logic coordinating fluid exchange with ongoing actuator cycles.

Synchronization prevents pressure fluctuations that could compromise hydraulic performance.

The system further comprises standardized adaptors for connection with service stations or mobile refueling units.

Adaptors ensure compatibility and interoperability across multiple robotic units using the same electrolyte standard.

The system further comprises automated verification of fluid compatibility prior to exchange.

Verification prevents introduction of incompatible electrolytes or contaminants into the fluid network.

The system further comprises safety interlocks to prevent overpressure, spillage, or exposure of the electrolyte to ambient conditions.

The system further comprises a communication interface reporting fluid status and exchange progress to remote operators or supervisory systems.

The system thereby enables safe, efficient, and continuous electrolyte exchange without interrupting robotic operation.

The system further integrates hydraulic actuation, distributed electrochemical energy storage, and thermal management within a unified, fault-tolerant fluid network to optimize robotic performance, resilience, and operational efficiency.

### BRIEF DESCRIPTION OF DRAWINGS

FIG. 1 is a system-level diagram illustrating the unified hydraulic-electric robotic power and actuation system with fluid conduits, actuators, and electrochemical conversion units.

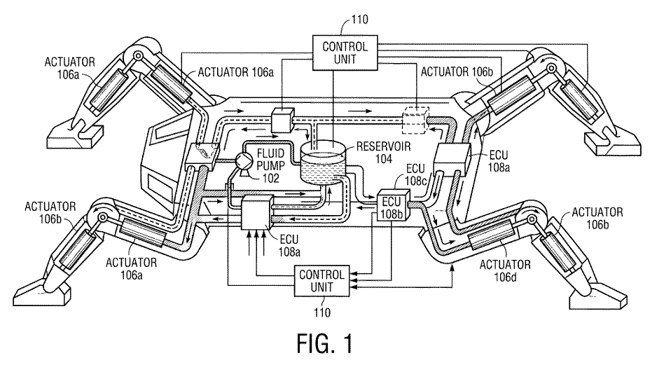

FIG. 2 is a schematic of the distributed fluid conduit network integrated within structural elements of the robotic chassis.

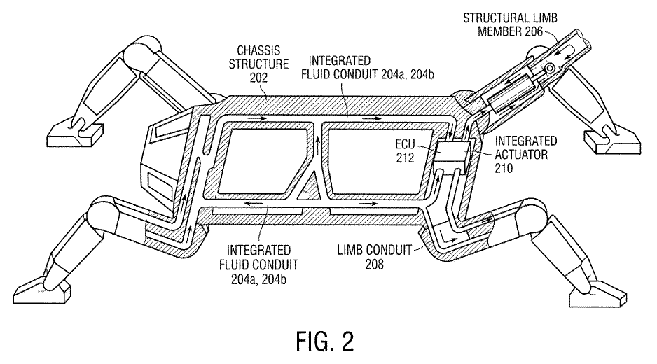

FIG. 3 is a diagram of a hydraulic actuator fluidly coupled to the circulating electrolyte loop, showing mechanical motion conversion.

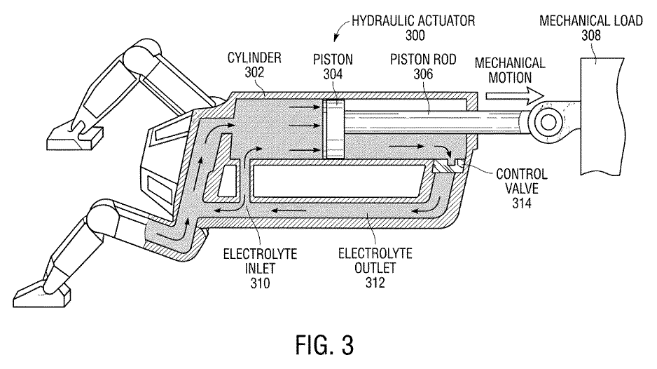

FIG. 4 is a block diagram of an electrochemical conversion unit extracting electrical energy from the circulating electrolyte.

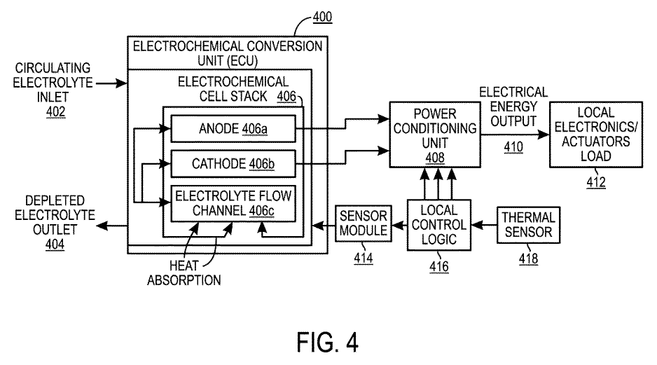

FIG. 5 is a flowchart illustrating energy recovery from actuator back-pressure to regenerate electrochemical potential in the working fluid.

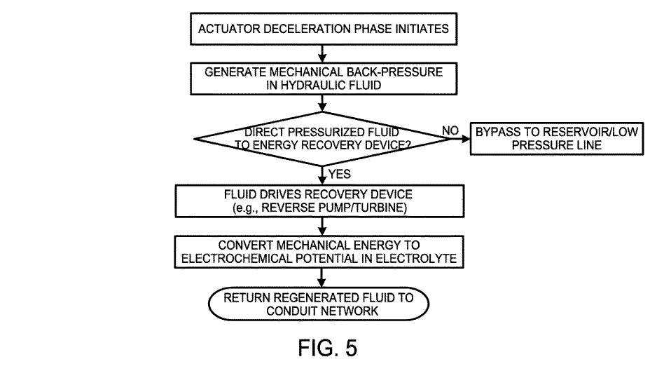

FIG. 6 is a schematic of the thermal management subsystem integrated with fluid conduits, showing heat absorption and dissipation pathways.

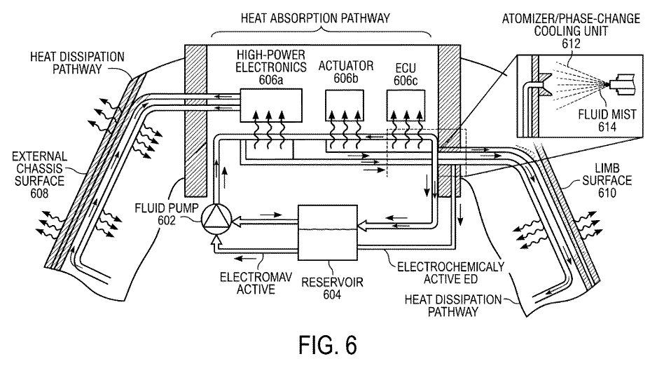

FIG. 7 is a diagram of the fluid exchange and conditioning interface, including sealed coupling, filtration subsystem, and additive injection module.

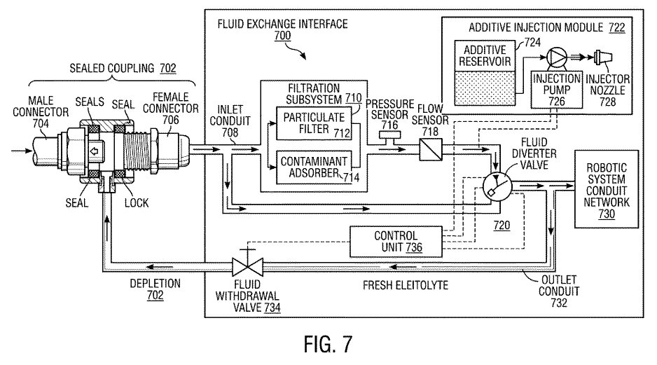

FIG. 8 is a block diagram showing sensor integration for monitoring fluid pressure, temperature, and electrochemical potential across actuators and conduit loops.

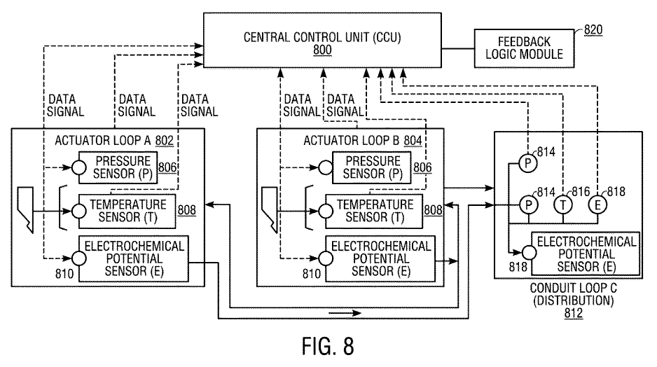

FIG. 9 is a flowchart of predictive fluid and energy management logic for balancing actuation demand, energy extraction, and thermal control.

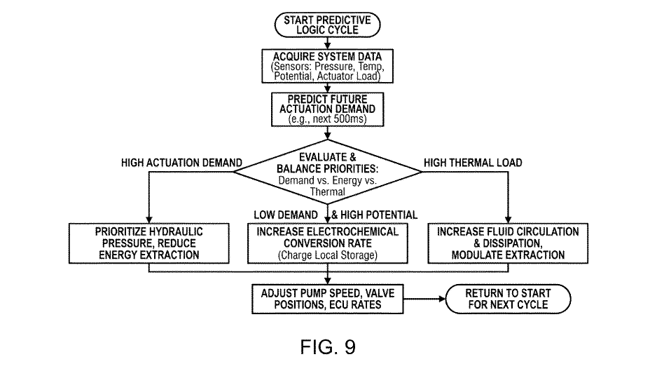

FIG. 10 is a schematic of modular actuator design with integrated sealing mechanisms and suspended sealing particles to prevent fluid leakage.

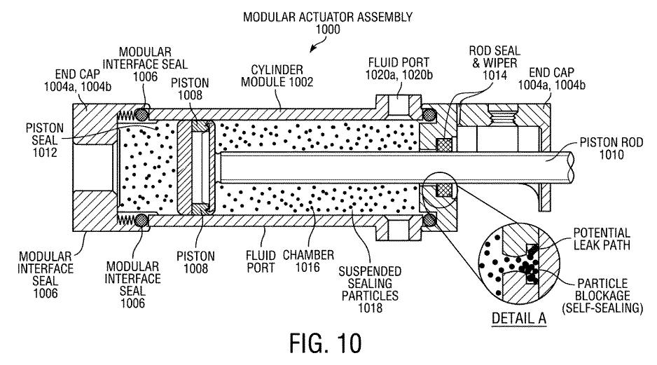

FIG. 11 is a block diagram of the maintenance flow operation for sustaining essential system functions during extended inactivity.

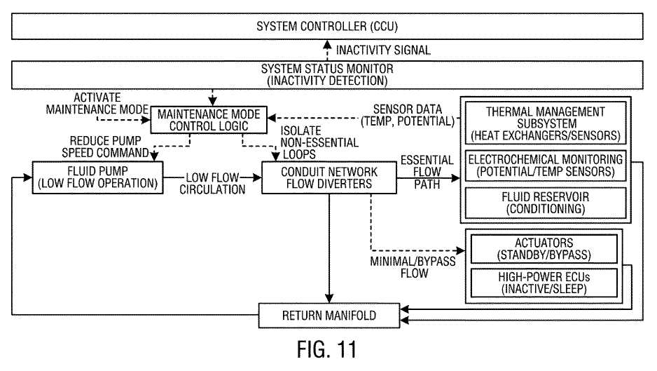

FIG. 12 is a system-level diagram illustrating multiple independent fluid loops for fault tolerance in case of partial conduit failure.

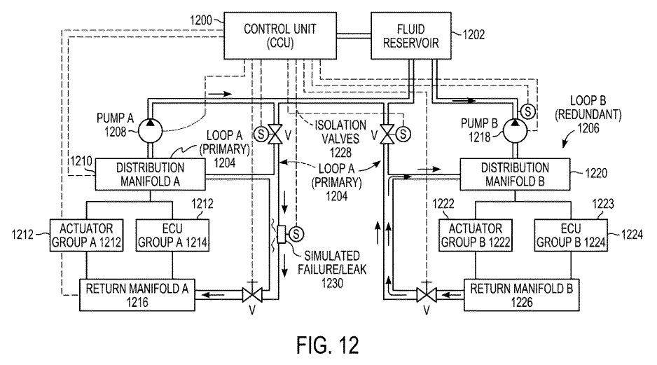

FIG. 13 is a schematic showing dynamic pressure modulation in hydraulic actuators for varying stiffness and load-bearing capability.

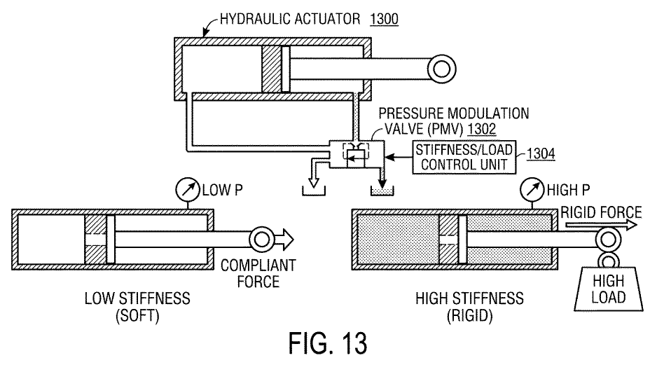

FIG. 14 is a block diagram illustrating multi-node communication and control of electrochemical conversion units for distributed energy delivery.

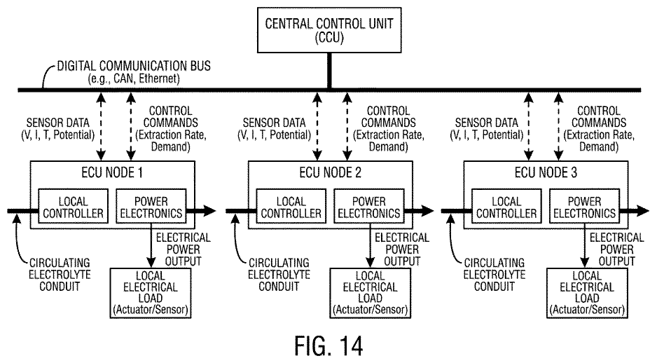

FIG. 15 is a system diagram of the robotic chassis showing integrated fluid conduits, actuators, thermal channels, and energy recovery devices.

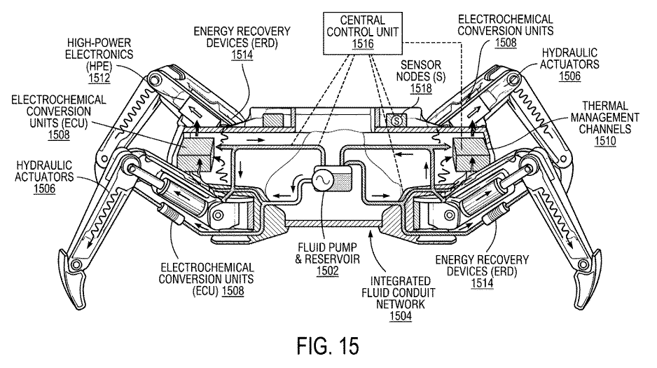

FIG. 16 is a diagram of the fluid exchange interface in operation with external service stations or mobile refueling units.

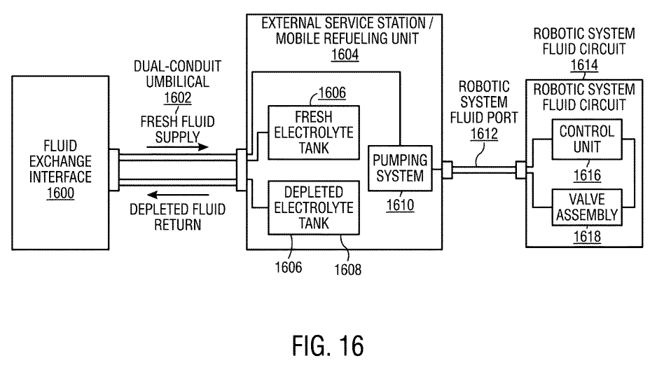

FIG. 17 is a flowchart of safety interlock logic including overpressure, over-temperature, and contamination detection.

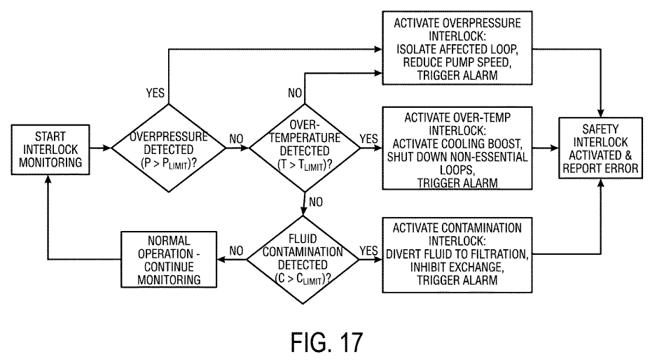

FIG. 18 is a functional diagram illustrating the feedback loop integrating actuator load, fluid pressure, and electrochemical energy availability.

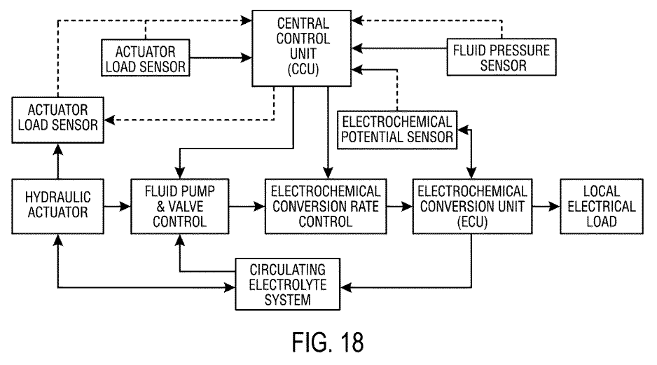

FIG. 19 is a diagram showing predictive actuation and fluid management control to optimize hydraulic, energy, and thermal performance.

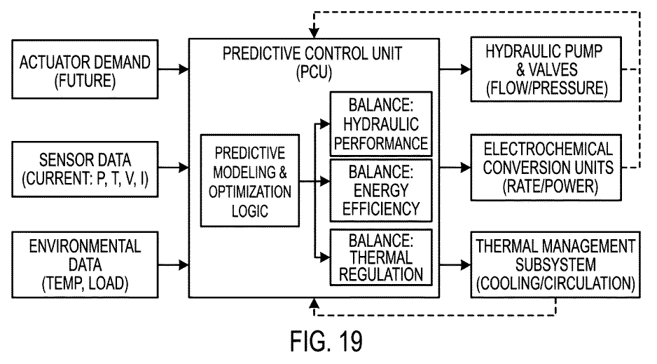

FIG. 20 is a system-level overview illustrating the integration of all subsystems, including hydraulic actuation, distributed energy storage, thermal management, and fluid exchange interfaces.

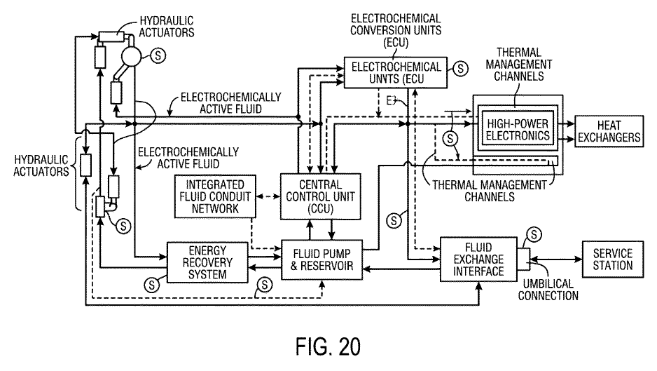

1. A unified hydraulic-electric robotic power and actuation system, comprising:
a fluid pump;
a distributed network of fluid conduits extending through structural elements of a robotic chassis;
a circulating working fluid comprising an electrolyte capable of electrochemical energy storage and transmission while exhibiting mechanical properties sufficient for pressurized hydraulic actuation;
one or more hydraulic actuators fluidly coupled to said conduits and configured to convert fluid pressure into mechanical motion; and
a plurality of electrochemical conversion units positioned at distributed locations along the conduit network, each configured to extract electrical energy from the circulating electrolyte and supply power to local electronic components.

2. A method for integrated thermal regulation and energy utilization in a robotic system, comprising:
circulating an electrochemically active hydraulic fluid through one or more heat-generating electronic components to absorb thermal energy;
transporting the heated fluid through peripheral regions of the robotic structure;
dissipating heat from the fluid to an [symbol] environment through external surfaces of the robot via conduction, convection, or radiation; and
recirculating the cooled fluid back toward a central fluid reservoir or pump.

3. A fluid exchange and conditioning interface for a robotic system, comprising:
a sealed fluid coupling configured for detachable connection to an external fluid supply;
a filtration subsystem configured to remove contaminants or degraded electrolyte species from a circulating working fluid; and
a control unit configured to coordinate withdrawal of depleted electrolyte and introduction of replenished electrolyte while the robotic system remains operational.

4. The system of claim 1, wherein mechanical back-pressure generated during actuator deceleration is used to drive fluid through an energy recovery device to regenerate electrochemical potential within the electrolyte.

5. The method of claim 2, wherein a portion of the working fluid is selectively released or atomized to enhance heat dissipation via phase-change cooling.

6. The interface of claim 3, wherein fluid exchange occurs without interrupting operation of a primary processing unit of the robot.

7. The system of claim 1, wherein hydraulic pressure is dynamically modulated to vary structural stiffness of a limb or load-bearing element.

8. The method of claim 2, further comprising utilizing heat generated by electrochemical reactions within the system to condition mechanical seals or fluid pathways in low-temperature environments.

9. The system of claim 1, wherein the working fluid includes suspended sealing particles configured to obstruct fluid leakage upon exposure to ambient pressure.

10. The interface of claim 3, wherein fluid is transferrable between two robotic systems via a detachable conduit.

11. The system of claim 1, wherein at least a portion of the fluid conduits are integrally formed within load-bearing structural components.

12. The method of claim 2, further comprising regulating external surface temperature to reduce detectability by infrared sensing systems.

13. The system of claim 1, wherein the conduit network comprises multiple independent fluid loops such that system operation continues upon failure of a subset of said loops.

14. The interface of claim 3, wherein the control unit analyzes electrolyte composition and introduces additives to restore electrochemical performance.

15. The system of claim 1, wherein the electrochemical conversion units are configured to deliver short-duration high-power electrical output exceeding nominal operating levels.

16. The method of claim 2, further comprising adjusting fluid viscosity by controlled heating to reduce pumping losses during high-speed operation.

17. The system of claim 1, wherein the working fluid is aqueous and substantially non-flammable.

18. The interface of claim 3, wherein the fluid coupling geometry conforms to a standardized specification enabling interoperability with multiple service stations.

19. The system of claim 1, wherein redistribution of fluid mass within the conduit network is used to alter the center of mass of the robot during operation.

20. The method of claim 2, further comprising reducing fluid circulation to a maintenance flow rate to sustain essential system functions during extended inactivity.
